(19) United States
(12) Patent Application Publication
(10) Pub. No.: US 2026/0328258 A1
(43) Pub. Date: Oct. 22, 2026

(54) VIBRATION DAMPER FOR A VEHICLE

(71) Applicants: thyssenkrupp Bilstein GmbH, Ennepetal (DE); thyssenkrupp AG, Essen (DE)

(72) Inventor: Michael FRITZ, Breckerfeld (DE)

(73) Assignees: thyssenkrupp Bilstein GmbH, Ennepetal (DE); thyssenkrupp AG, Essen (DE)

(21) Appl. No.: 19/529,366

(22) Filed: Feb. 4, 2026

(30) Foreign Application Priority Data
Feb. 4, 2025 (DE) 10 2025 104 064.8

(51) Int. Cl. F16F 9/516

(52) U.S. Cl. CPC F16F 9/516; F16F 2222/12; F16F 2232/08

(57) ABSTRACT

A vibration damper for a vehicle comprises a damper tube filled with hydraulic fluid, and a working piston, which is connected to a piston rod and is arranged movably back and forth within the damper tube, the interior of the damper tube being divided by the working piston into a first working chamber on the piston rod side and a second working chamber away from the piston rod, wherein the vibration damper also comprises an outer tube arranged coaxially around the damper tube, and wherein a compensation chamber at least partially filled with hydraulic fluid is located between the damper tube and the outer tube, wherein the vibration damper has at least two bypass paths for conducting hydraulic fluid past the working piston, wherein the bypass paths are arranged in such a way that hydraulic fluid can flow through them exclusively when the working piston is in a position outside a center region of the damper tube.

### CROSS REFERENCE TO RELATED APPLICATION

This application is a U.S. Non-Provisional that claims priority to German Patent Application No. DE 10 2025 104 064.8, filed Feb. 4, 2025, the entire content of which is incorporated herein by reference.

### FIELD

The present disclosure relates to a vibration damper, in particular a steering damper, for a vehicle, comprising a rebound stage suspension arrangement and a compression stage suspension arrangement.

### BACKGROUND

Vibration dampers, in particular a steering damper, are usually used to stabilize the steering when there is a high degree of excitation, in particular in the case of travel on very uneven terrain or cornering at high speeds.

DE102017113299A1 discloses a steering damper. It has been found to be a problem that when there is a high degree of excitation combined with a high damping force, the starting position of the steering damper, i.e. the position in which the vehicle is travelling straight ahead, is reached only after a delay. In the worst case, the excitation will cause oscillations to build up on the steering system, resulting in circular travel, uncontrolled rocking of the steering system or “shuddering”. This presents a very high safety risk. In such cases, travelling straight ahead frequently requires a corresponding manual action by means of the steering wheel.

Thus a need exists to specify a vibration damper, in particular a steering damper, which reliably returns to its starting position after an excitation, so that the vehicle is automatically set to travel in a straight line.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a two-tube vibration damper in a longitudinal sectional view according to one exemplary embodiment.

FIG. 2 shows a schematic illustration of a vibration damper in a longitudinal sectional view according to a further exemplary embodiment.

FIG. 3 shows a schematic illustration of a vibration damper in a longitudinal sectional view according to a further exemplary embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

According to a first aspect, a vibration damper for a vehicle comprises a damper tube filled with hydraulic fluid, and a working piston, which is connected to a piston rod and is arranged movably back and forth inside the damper tube, the interior of the damper tube being divided by the working piston into a first working chamber and a second working chamber. The vibration damper also optionally comprises an outer tube arranged coaxially around the damper tube, wherein a compensation chamber at least partially filled with hydraulic fluid is located between the damper tube and the outer tube. The vibration damper has at least two bypass paths for conducting hydraulic fluid past the working piston, wherein the bypass paths are arranged in such a way that hydraulic fluid can flow through them exclusively when the working piston is in a position outside a center region of the damper tube.

The vibration damper is preferably a steering damper, which is mounted between an axle of a vehicle, in particular the steering axle, and the steering rod and/or the vehicle body. The bypass paths ensure a lower degree of damping of the working piston outside a center region that includes the center position of the working piston, so that, in the case of a steering damper, travel straight ahead is re-set very easily after a deflection. In the center region of the damper tube, the working piston undergoes a higher degree of damping than it does outside this center region, making deflection more difficult and making it easier to return to the starting position after a deflection.

The vibration damper is, for example, a single-tube or multi-tube vibration damper. For example, a multi-tube vibration damper for a vehicle comprises an outer tube and an inner tube coaxial with the outer tube, with a compensation chamber for receiving hydraulic fluid being formed between the outer tube and the inner tube, and comprises a working piston, which is connected to a piston rod and is arranged movably back and forth inside the inner tube, the interior of the inner tube being divided by the working piston into a first working chamber and a second working chamber. The compensation chamber is preferably at least partially filled with a gas, in particular at the upper end. The outer tube preferably forms at least partially the housing of the vibration damper. The inner surface of the inner tube is preferably formed as a guide of the working piston. The working piston preferably has a valve device by which the first and the second working chamber are connected to each other. The inner tube has in particular at least one through-opening, which fluidically connects the first working chamber on the piston rod side to the annular chamber, the through-opening being formed in the first working chamber. In the case of a single-tube vibration damper, an outer tube can also be provided. The inner tube is referred to preferably as the damper tube and, as described above with reference to the inner tube, receives the piston rod and the working piston.

In the case of a multi-tube vibration damper, the vibration damper has in particular a closure package which is designed and arranged to seal off the interior of the outer tube and the inner tube fluidically on the piston rod side. The end of the inner tube on the piston rod side is preferably fastened to the closure package. Opposite from the closure package, at the end away from the piston rod, the interior of the outer tube and in particular of the inner tube are preferably fluidically sealed off by means of a bottom piece. A bottom valve, which is mounted in particular at the end of the inner tube away from the piston rod, is mounted in particular on the bottom piece. The second working chamber is preferably fluidically connected to the compensation chamber via the bottom valve. The bottom valve is preferably a check valve through which flow can pass in both directions or only in one direction. For example, the bottom valve is designed as a check valve in the rebound direction, in the case of a piston movement in a direction out of the inner tube, and is designed as a characteristic-defining valve in the compression direction, in the case of a piston movement into the inner tube.

In the case of a single-tube vibration damper, the vibration damper has in particular a closure package which is designed and arranged to seal off the interior of the outer tube fluidically on the piston rod side. The end of the outer tube on the piston rod side is preferably fastened to the closure package. Opposite from the closure package, at the end away from the piston rod, the interior of the outer tube is preferably fluidically sealed off by means of an axially movable separation device, in particular a sealing element. The separation device preferably separates a gas chamber, adjoining it in the axial direction, from a hydraulic chamber filled with hydraulic fluid. For example, the vibration damper does not have a bottom valve but merely a bottom piece, the bottom piece forming a fluid-tight closure of the damper tube, and an adjustment valve is provided which is external with respect to the damper tube and generates the damping action for example in the compression direction. It is also conceivable, in particular in the case of a single-tube vibration damper, to replace the bottom piece with a separating piston which separates the working chamber that is away from the piston rod from a gas chamber. The single-tube vibration damper optionally has an outer tube and an inner tube, which is referred to as the damper tube, the damper tube of the single-tube vibration damper preferably not extending as far as the bottom valve and the closure package, but rather being at a spacing therefrom, so that hydraulic fluid can flow between the bottom valve and the inner tube, and between the closure package and the inner tube. With preference, the damper tube of the single-tube vibration damper is not fluid-tightly connected to the closure package and/or the bottom valve.

In the following description, the term vibration damper should be understood as meaning both a multi-tube vibration damper and a single-tube vibration damper, the damper tube being the inner tube of a multi-tube vibration damper. In the following, a movement in the rebound direction is understood as a movement in the direction of the closure package into the region of the shock absorber on the piston rod side, and a movement in the compression direction is understood as a movement in the direction of the bottom valve into the region of the shock absorber away from the piston rod. The closure package is preferably coaxial with the piston rod and encloses the latter around the circumference.

The center position of the working piston is understood as meaning the position of the working piston in the axial center of the damper tube, in particular in an undeflected position in which the first and the second working chamber are substantially at the same pressure. With preference, the center region of the damper tube includes the axial center of the damper tube, in which the working piston is in the center position. The axial extent of the center region preferably corresponds to 1 to 5, in particular 2 to 4, preferably 3 times the thickness, in particular the axial extent, of the working piston. Hydraulic fluid can flow through the bypass paths preferably exclusively when the working piston is in a position completely outside the center region of the damper tube.

According to a first embodiment, the vibration damper, in particular the bypass paths of the vibration damper, has a rebound stage bypass path for conducting hydraulic fluid past the working piston in the rebound stage and a compression stage bypass path for conducting hydraulic fluid past the working piston in the compression stage. The rebound stage bypass path and the compression stage bypass path are preferably separate from one another and hydraulic fluid can flow through them separately. This makes it possible to set the bypass paths for the rebound stage and compression stage separately.

According to a further embodiment, the bypass paths each comprise at least one flow passage, formed in the damper tube, for establishing a fluidic connection between the compensation chamber and the first and/or second working chamber. The flow passages are designed for example in the form of through-bores in the damper tube. With preference, the damper tube has four flow passages spaced apart from one another. In particular, the spacing between the two central flow passages corresponds to the center region of the damper tube.

According to a further embodiment, at least one of the flow passages is located in a region of the damper tube that is outside the center region of the damper tube. With preference, two flow passages are located outside and two flow passages are located inside the center region of the damper tube.

According to a further embodiment, at least one bypass path comprises a radial widening of the damper tube, in particular a widening in diameter of the damper tube. The radial widening of the damper tube is preferably located completely outside the center region of the damper tube. It is also conceivable that at least one bypass path comprises an axial groove in at least one end portion of the damper tube. Optionally, the damper tube has a narrowing in diameter in the center region, this narrowing having a diameter that corresponds to the outside diameter of the working piston and fluid-tightly terminating therewith. Outside the center region, the damper tube has for example two widenings in diameter, so that the bypass paths are formed between the working piston and the damper tube. One widening in diameter is located in the first working chamber and the further widening in diameter is located in the second working chamber.

According to a further embodiment, the compensation chamber contains a separation device for hydraulically separating the compensation chamber into a first compensation chamber and a second compensation chamber. The separation device is preferably designed in the form of a separation disc or separation sleeve and lies fluid-tightly and positionally fixedly between the outer surface of the damper tube and the inner surface of the outer tube. With preference, the separation disc is fastened to the damper tube and/or the outer tube, for example pressed or integrally bonded between them. The first compensation chamber is formed for example at the end of the compensation chamber facing in the direction of the closure package, in particular at least partially around the first working chamber. The second compensation chamber is formed for example at the end of the compensation chamber facing in the direction of the bottom valve, in particular around the second working chamber. The first and the second compensation chamber are preferably the same size. The second compensation chamber is in particular fluidically connected to the second working chamber via the bottom valve.

According to a further embodiment, the separation element is located at the axial center of the compensation chamber and/or of the damper tube, so that the compensation chamber is preferably divided into two approximately equally sized regions, the first compensation chamber and the second compensation chamber.

According to a further embodiment, a check valve is located in the separation device. Hydraulic fluid can preferably flow through the check valve from the second compensation chamber into the first compensation chamber. With preference, the check valve is arranged in such a way that it prevents a hydraulic flow from the first compensation chamber into the second compensation chamber. In particular, the check valve serves for venting in the case of foaming of the hydraulic fluid, a gas chamber optionally being formed in the compensation chamber, in particular in the second compensation chamber.

According to a further embodiment, a first closure body for fluid-tightly closing the first compensation chamber and a second closure body for at least fluid-tightly closing the second compensation chamber are mounted on the compensation chamber. With preference, the closure bodies are circular-disc-shaped or in the form of sleeves. In particular, the first closure body is mounted at the end of the first compensation chamber facing in the direction of the closure package and fluid-tightly closes off the first compensation chamber. In particular, the second closure body is mounted at the end of the second compensation chamber facing in the direction of the closure package and fluid-tightly closes off the second compensation chamber. For example, the first and the second closure body each have at least one check valve. For example, each closure body has two oppositely aligned check valves.

According to a further embodiment, the vibration damper has a first and a second flow passage for hydraulically connecting the first working chamber to the first compensation chamber, and a third and a fourth flow passage for hydraulically connecting the second working chamber to the second compensation chamber.

According to a further embodiment, the rebound stage bypass path is formed by the first and the second flow passage and the first compensation chamber. The compression stage bypass path is preferably formed by the third and the fourth flow passage and the second compensation chamber.

According to a further embodiment, the flow passages are preferably all formed in the damper tube. With preference, the first compensation chamber has two flow passages in the damper tube, a first flow passage and a second flow passage. The first flow passage is formed at the end of the damper tube on the closure package side. The second flow passage is preferably formed in the damper tube at the end of the first compensation chamber facing in the direction of the separation device. The first and the second flow passage are in particular each formed in the damper tube in such a way that they hydraulically connect the first compensation chamber to the first working chamber. The vibration damper optionally has a rebound stop buffer, against which the working piston can lie in the rebound stage. With preference, the spacing between the first flow passage and the rebound stop buffer is at least the width of the working piston, so that when the working piston is supported on the rebound stop buffer, the working piston at least partially or completely covers the first flow passage.

The damper tube preferably has two further flow passages, specifically a third and a fourth flow passage, at the axial height of the second working chamber, in particular of the second compensation chamber. The third flow passage is formed by way of example in the damper tube at the end of the second compensation chamber facing in the direction of the separation device. The third and the fourth flow passage are each formed in the damper tube in such a way that they hydraulically connect the second compensation chamber to the second working chamber. With preference, the spacing between the fourth flow passage and the bottom valve is at least the width of the working piston, so that when the working piston is supported on the bottom valve, the working piston at least partially or completely covers the fourth flow passage.

The flow passages are preferably arranged in such a way that, when the working piston is in the center position, they are not covered by the working piston and are completely opened up.

According to a further embodiment, the first flow passage is formed in the first closure body, the second and the third flow passage are formed in the damper tube and the fourth flow passage is formed in the second closure body. A flow passage is preferably located in each of the closure bodies. With preference, the first closure body has the first flow passage, the first flow passage being designed by way of example in the form of a check valve, which allows a hydraulic flow from the first working chamber into the first compensation chamber and prevents it in the opposite direction. The second and the third flow passage are preferably formed in the damper tube. The second closure body preferably has the fourth flow passage, the fourth flow passage being designed in particular in the form of a check valve, which allows a hydraulic flow from the second working chamber into the second compensation chamber and prevents it in the opposite direction. The rebound stage bypass path is formed for example by the first and the second flow passage and the first compensation chamber. The compression stage bypass path is preferably formed by the third and the fourth flow passage and the second compensation chamber.

According to a further embodiment, the closure bodies are circular or in the form of sleeves.

The present disclosure also comprises a vehicle which comprises a steering rod, a steering axle and a vibration damper as described above, the vibration damper being fastened to the steering rod and/or to the steering axle and/or to the vehicle body.

The present disclosure is explained in more detail below on the basis of several exemplary embodiments, with reference to the accompanying figures.

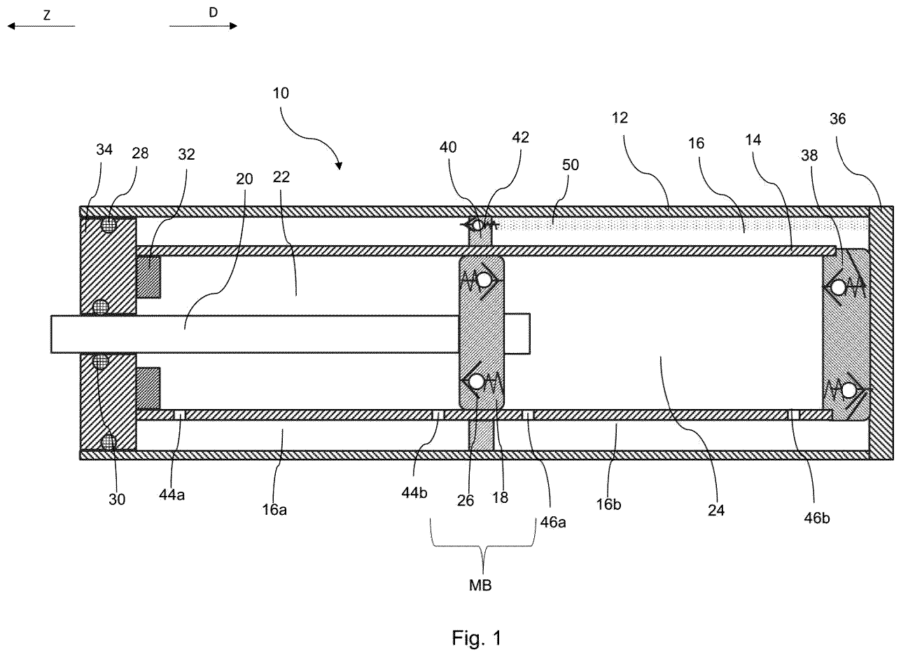

FIG. 1 shows a vibration damper 10, the vibration damper 10 being, by way of example, a multi-tube vibration damper, by way of example a two-tube vibration damper. The vibration damper 10 is preferably designed in the form of a steering damper and is in particular mounted on a steering rod and axle, in particular steering axle, of a vehicle, which are not illustrated in the figures. The vibration damper 10 has an outer tube 12, which forms an outer surface, in particular a housing, of the vibration damper 10. A damper tube 14, also referred to as inner tube 14, is located inside the outer tube 12, coaxially therewith. Formed between the outer tube 12 and the inner tube 14 is a compensation chamber 16, which is preferably at least partially or completely filled with a hydraulic fluid. For example, the compensation chamber 16 is partially filled with a gas.

Inside the inner tube 14, a working piston 18 connected to a piston rod 20 is arranged in such a way that it is movable within the inner tube 14, wherein the inner tube 14 is preferably designed as a guide of the working piston 18. The working piston 18 preferably has a valve device 26. For example, the valve device 26 comprises a rebound stage valve, for damping the piston movement in the rebound stage, and a compression stage valve for damping the piston movement in the compression stage. Preferably, the valves are each formed by a passage opening through the piston and a valve disc pack. The working piston 18 divides the interior of the inner tube 14 into a first working chamber 22, which is arranged on the piston rod side, and a second working chamber 24, which is arranged away from the piston rod. The piston rod 20 is preferably connectable, by way of its end protruding from the damper tube 14, to the steering axle or the steering rod of the vehicle.

The interior of the outer tube 12 is fluidically sealed off on the piston rod side by means of a closure package 34. Opposite from the closure package 34, at the end away from the piston rod, the interior of the outer tube 12 is fluidically sealed off by means of a bottom piece 36. By way of example, a bottom valve 38, which is mounted in particular on the end of the inner tube 14 away from the piston rod, is arranged on the bottom piece 36. The bottom valve 38 is preferably a check valve through which a flow can pass in both directions or only in one direction. The second working chamber 24 is preferably fluidically connected to the compensation chamber 16 by way of the bottom valve 38. The end of the inner tube 14 on the piston rod side is preferably fastened to the closure package 34.

By way of example, the outer tube 12 is sealed off in relation to the closure package 34, at the end region on the piston rod side, by means of a seal 28. With preference, the seal 28 is designed in the form of a sealing ring and is located between the outer tube 12 and the closure package 34. The closure package 34 is sealed off in relation to the piston rod 20 via a further sealing ring 30, the sealing ring being mounted by way of example in a groove in the closure package 34 and the piston rod 20 being mounted with the ability to move relative to the sealing ring 30, the piston rod preferably fluid-tightly sliding along the sealing ring 30. The vibration damper 10 further has, by way of example, a rebound stop buffer 32, against which the working piston 18 can lie in the rebound stage.

Inside the compensation chamber 16 there is, by way of example, a separation device 40 for separating the compensation chamber 16 into a first compensation chamber 16a and a second compensation chamber 16b. The separation device 40 is preferably designed in the form of a separation disc and lies fluid-tightly and positionally fixedly between the outer surface of the damper tube 14 and the inner surface of the outer tube 12. With preference, the separation disc is fastened to the damper tube 14 and/or the outer tube 12, for example pressed or integrally bonded between them. By way of example, the separation element 40 is located at the axial center of the compensation chamber 16 and/or of the damper tube 14, so that the compensation chamber 16 is preferably divided into two approximately equally sized regions, the first compensation chamber 16a and the second compensation chamber 16b. The first compensation chamber 16a is formed by way of example at the end of the compensation chamber 16a facing in the direction of the closure package 34, in particular at least partially around the first working chamber 22 on the piston rod side. The second compensation chamber 16b is formed by way of example at the end of the compensation chamber 16 facing in the direction of the bottom valve 38, in particular around the second working chamber 24 away from the piston rod. The first and the second compensation chamber 16a, b are preferably the same size. The second compensation chamber 16b is in particular fluidically connected to the second working chamber 24 via the bottom valve 38.

The separation device 40 contains, by way of example, a check valve 42 through which hydraulic fluid can flow from the second compensation chamber 16b into the first compensation chamber 16a. With preference, the check valve 42 is arranged in such a way that it prevents a hydraulic flow from the first compensation chamber 16a into the second compensation chamber 16b. In particular, the check valve serves for venting in the case of foaming of the hydraulic fluid, a gas chamber 50 being formed in the compensation chamber 16, in particular in the second compensation chamber 16b.

The damper tube 14 has, by way of example, a plurality of flow passages 44, 46 for hydraulically connecting the compensation chamber 16 to the first or the second working chamber 22, 24 inside the damper tube 14. By way of example, the first compensation chamber 16a has two flow passages 44a, b in the damper tube 14, a first flow passage 44a and a second flow passage 44b. The first flow passage 44a is formed at the end of the damper tube 14 on the closure package side. The second flow passage 44b is formed by way of example in the damper tube 14 at the end of the first compensation chamber 16a facing in the direction of the separation device 40. With preference, the second flow passage 44b, starting from a center position of the working piston 18 in which the latter is located in the axial center of the damper tube 14, is located in a region of the damper tube 14 against which the working piston 18 does not lie. The first and the second flow passage 44a, b are each formed in the damper tube 14 in such a way that they hydraulically connect the first compensation chamber 16a to the first working chamber 22. With preference, the spacing between the first flow passage 44a and the rebound stop buffer 32 is at least the width of the working piston 18, so that, when the working piston 18 is supported on the rebound stop buffer 32, the working piston at least partially or completely covers the first flow passage 44a. The spacing between the second flow passage 44b and the axial center of the damper tube 14 amounts to at least half the width of the working piston 18, so that in the center position the working piston 18 does not cover the second flow passage 44b and completely opens it up. The width of the working piston 18 is understood as meaning the axial extent.

The damper tube 14 preferably has two further flow passages 46a, b, specifically a third and a fourth flow passage 46a, b, at the axial height of the second working chamber 24, in particular of the second compensation chamber 16b. The third flow passage 46a is formed by way of example in the damper tube 14 at the end of the second compensation chamber 16b facing in the direction of the separation device 40. With preference, the third flow passage 46a, starting from a center position of the working piston 18, is located in a region of the damper tube 14 against which the working piston 18 does not lie. The third and the fourth flow passage 46a, b are each formed in the damper tube 14 in such a way that they hydraulically connect the second compensation chamber 16b to the second working chamber 24. With preference, the spacing between the fourth flow passage 46b and the bottom valve 38 is at least the width of the working piston 18, so that when the working piston 18 is supported on the bottom valve 38, the working piston at least partially or completely covers the fourth flow passage 46b. The spacing between the third flow passage 46a and the axial center of the damper tube 14 amounts to at least half the width of the working piston 18, so that in the center position the working piston 18 does not cover the third flow passage 46a and completely opens it up.

The flow passages 44, 46 are preferably arranged in such a way that, when the working piston is in the center position, they are not covered by the working piston 18 and are completely opened up. The vibration damper 10 therefore preferably has a first and a second bypass path, which are each designed and arranged such that the hydraulic fluid is at least partially conducted past the working piston 18 in a position outside the center position, in particular the center region MB. The bypass paths are preferably located parallel to the working piston 18, in particular the valve device 26 of the working piston 18.

During operation of the vibration damper 10 in FIG. 1, the working piston 18 is moved for example from the center position shown in FIG. 1. In the case of a movement of the working piston 18 in the rebound direction Z, hydraulic fluid flows through the valve device 26 of the working piston 18 from the first working chamber 22 into the second working chamber 24. When the working piston 18 has gone past the second flow passage 44b and is located axially between the first and the second flow passage 44a, b, the hydraulic fluid additionally flows through the first flow passage into the first compensation chamber 16a and from there via the second flow passage 44b into the second working chamber 24. The flow path bypasses the working piston 18 and thus ensures a lower degree of damping of the movement of the working piston 18 in a position between the first and the second flow passage 44a, b. The same occurs in the compression stage, wherein the movement of the working piston 18 in a position between the third and the fourth flow passage is dampened less than in the middle position of the working piston 18. In the compression stage, the bypass is formed by the third flow passage 46a, the second compensation chamber 16b and the fourth flow passage 46b. The described arrangement of the flow passages 44, 46 thus ensures a high degree of damping of the working piston movement within a first movement range which includes the region of the center position, and a lower degree of damping within a second movement range between the first and the second or the third and the fourth flow passage.

The vibration damper 10 preferably has a rebound stage bypass path, which is formed by the first and the second flow passage 44a, b and the first compensation chamber 16a, and a compression stage bypass path, which is formed by the third and the fourth flow passage 46a, b and the second compensation chamber 16b.

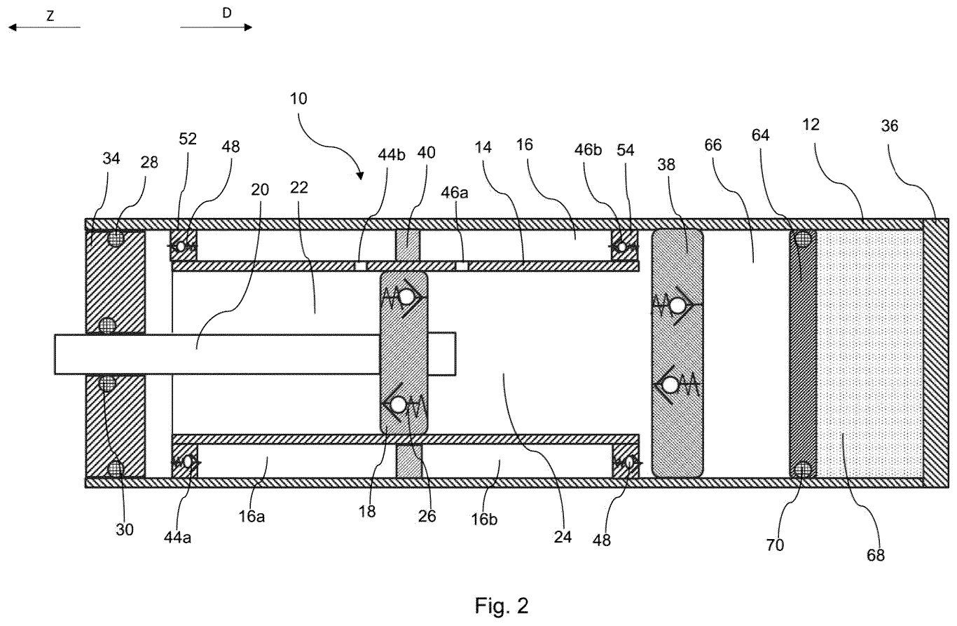

FIG. 2 shows a vibration damper 10 which largely corresponds to the vibration damper 10 in FIG. 1, identical elements being provided with the same reference signs. The vibration damper 10 in FIG. 2 is designed by way of example in the form of a single-tube vibration damper 10, the inner tube 14 axially not extending as far as the bottom valve 38 and the closure package 34, but rather being at a spacing therefrom, so that hydraulic fluid can flow between the bottom valve 38 and the inner tube 14, and between the closure package 34 and the inner tube 14. With reference to the exemplary embodiment in FIG. 2, the inner tube 14 is also referred to as the damper tube 14. The bottom valve 38 and the closure package 34 preferably fluid-tightly seal off the outer tube 12. Also by contrast to FIG. 1, the vibration damper 10 in FIG. 2 comprises a separating piston 64, which separates a hydraulic chamber 66, located between the bottom valve 38 and the bottom piece 36, from a gas chamber 68. The separating piston 64 can move axially inside the outer tube 12 and lies fluid-tightly against the inner wall of the outer tube 12. By way of example, the separating piston 64 is fluid-tightly sealed off in relation to the outer tube 12 via a sealing ring 70.

Optionally, the gas chamber 68, the separating piston 64 and the hydraulic chamber 66 are located in an external gas tank outside the outer tube 12. In this case, the hydraulic chamber 66 is fluidically connected to the interior of the outer tube 12 via the bottom valve 38 located inside the outer tube 12. Such an arrangement takes up less space.

The vibration damper 10 in FIG. 2 preferably has two closure bodies 52, 54, which are arranged in such a way that they fluid-tightly seal off the compensation chamber 16 at the end regions. With preference, the closure bodies 52, 54 are circular-disc-shaped. In particular, the first closure body 52 is mounted at the end of the first compensation chamber 16a facing in the direction of the closure package 34 and fluid-tightly closes off the first compensation chamber 16a. In particular, the second closure body 54 is mounted at the end of the second compensation chamber 16b facing in the direction of the closure package 34 and fluid-tightly closes off the second compensation chamber 16b. By way of example, the first and the second closure body 52, 54 each have at least one check valve 48. By way of example, each closure body 52, 54 has two oppositely aligned check valves 48.

In the exemplary embodiment in FIG. 2, the damper tube 14 has only two through-bores, which form two flow passages 44b, 46a. A flow passage 44a, 46b is preferably located in each of the closure bodies 52, 54. With preference, the first closure body 52 has the first flow passage 44a, the first flow passage 44a being designed by way of example in the form of a check valve, which allows a hydraulic flow from the first working chamber 22 into the first compensation chamber 16a and prevents it in the opposite direction. The second and the third flow passage 44b, 46a are preferably formed in the damper tube 14. The second closure body 54 preferably has the fourth flow passage 46b, the fourth flow passage 46b being designed by way of example in the form of a check valve, which allows a hydraulic flow from the second working chamber 24 into the second compensation chamber 16b and prevents it in the opposite direction. In the exemplary embodiment in FIG. 2, the rebound stage bypass path is formed by way of example by the first and the second flow passage 44a, b and the first compensation chamber 16a. The compression stage bypass path is preferably formed by the third and the fourth flow passage 46a, b and the second compensation chamber 16b.

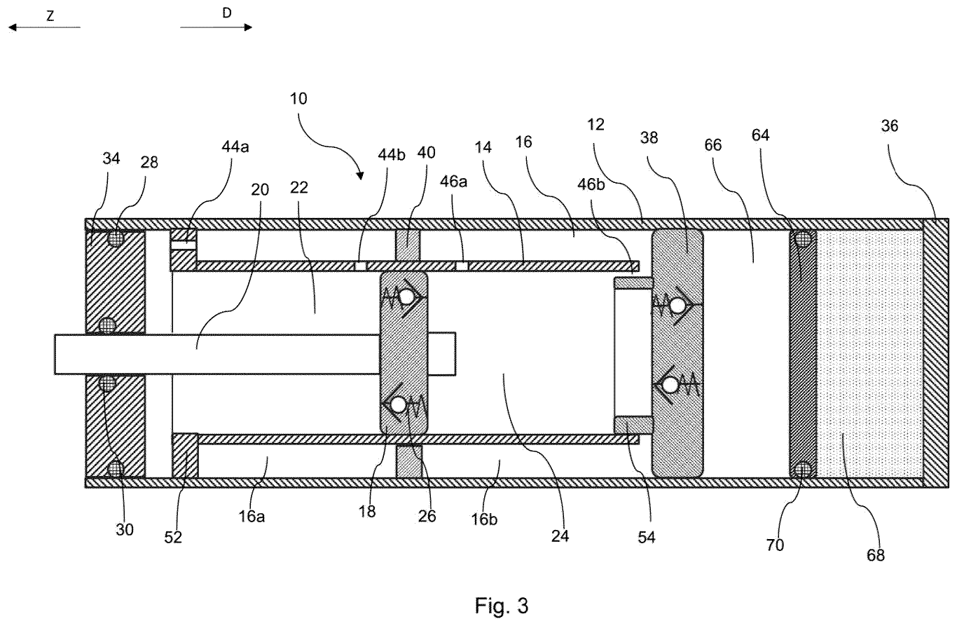

FIG. 3 shows a further exemplary embodiment of a single-tube vibration damper 10 substantially corresponding to that in FIG. 2, identical elements being provided with the same reference signs. By contrast to the vibration damper in FIG. 2, the vibration damper 10 in FIG. 3 has a second closure body 54 which is mounted on the bottom valve 36. The second closure body 54 is by way of example circular or in the form of a sleeve and has an outside diameter which corresponds to the inside diameter of the damper tube 14. The second closure body 54 preferably lies fluid-tightly against the damper tube 14 and thus fluid-tightly closes off the second compensation chamber 16b with respect to the second working chamber. By way of example, the outer surface of the second closure body 54 has an axial cutout, which forms the fourth flow passage 46b and via which the second working chamber 24 is fluidically connected to the second compensation chamber 16b.

The first closure body 52 substantially corresponds to the first closure body 52 of the vibration damper 10 in FIG. 2, the first flow passage 44a being designed in the form of a through-bore in the first closure body 52 and by way of example no check valve being provided.

### LIST OF REFERENCE SIGNS

10 Vibration damper
12 Outer tube
14 Damper tube/inner tube
16 Compensation chamber
16a First compensation chamber
16b Second compensation chamber
18 Working piston
20 Piston rod
22 First working chamber
24 Second working chamber
26 Valve device of the working piston
28 Seal
30 Sealing ring
32 Rebound stop buffer
34 Closure package
36 Bottom piece
38 Bottom valve
40 Separation device
42 Check valve
44 Flow passages
44a First flow passage
44b Second flow passage
46 Flow passages
46a Third flow passage
46b Fourth flow passage
50 Gas chamber
52 First closure body
54 Second closure body
64 Separating piston
66 Hydraulic chamber
68 Gas chamber
70 Sealing ring
MB Center region

1. A vibration damper for a vehicle, comprising:
a damper tube filled with hydraulic fluid;
a working piston, which is connected to a piston rod, is arranged movably back and forth inside the damper tube and has a valve device, wherein an interior of the damper tube is divided by the working piston into a first working chamber on the piston rod side and a second working chamber away from the piston rod; and
at least two bypass paths for conducting hydraulic fluid past the working piston, wherein the bypass paths are arranged in such a way that hydraulic fluid can flow through them exclusively when the working piston is in a position outside a center region of the damper tube.

2. The vibration damper according to claim 1, wherein the vibration damper has an outer tube arranged coaxially around the damper tube and wherein a compensation chamber at least partially filled with hydraulic fluid is located between the damper tube and the outer tube.

3. The vibration damper according to claim 1, wherein the vibration damper has a rebound stage bypass path for conducting hydraulic fluid past the working piston in the rebound stage and a compression stage bypass path for conducting hydraulic fluid past the working piston in the compression stage.

4. The vibration damper according to claim 1, wherein at least one bypass path comprises a radial widening of the damper tube.

5. The vibration damper according to claim 1, wherein the bypass paths each comprise at least one flow passage, formed in the damper tube, for establishing a fluidic connection between the compensation chamber and the first and/or second working chamber.

6. The vibration damper according to claim 1, wherein the compensation chamber contains a separation device for hydraulically separating the compensation chamber into a first compensation chamber and a second compensation chamber.

7. The vibration damper according to claim 6, wherein the separation device is mounted in the axial center of the compensation chamber and/or of the damper tube.

8. The vibration damper according to claim 6, wherein at least one of the flow passages is located in a region of the damper tube that is outside the center region of the damper tube.

9. The vibration damper according to claim 6, wherein a check valve is located in the separation device.

10. The vibration damper according to claim 6, wherein a first closure body for fluid-tightly closing the first compensation chamber and a second closure body for at least fluid-tightly closing the second compensation chamber are mounted on the compensation chamber.

11. The vibration damper according to claim 10, wherein the closure bodies are circular or in the form of sleeves.

12. The vibration damper according to claim 6, wherein the vibration damper has a first and a second flow passage for hydraulically connecting the first working chamber to the first compensation chamber, and a third and a fourth flow passage for hydraulically connecting the second working chamber to the second compensation chamber.

13. The vibration damper according to claim 12, wherein the rebound stage bypass path is formed by the first and the second flow passage and the first compensation chamber, and wherein the compression stage bypass path is formed by the third and the fourth flow passage and the second compensation chamber.

14. The vibration damper according to claim 12, wherein the flow passages are formed in the damper tube.

15. The vibration damper according to claim 12, wherein the first flow passage is formed in the first closure body, the second and the third flow passage are formed in the damper tube and the fourth flow passage is formed in the second closure body.

16. A vehicle, comprising:
a vehicle body;
a steering rod;
a steering axle; and
a vibration damper according to claim 1;
wherein the vibration damper is fastened to the steering rod and/or to the steering axle and/or to the vehicle body.
